(19) United States
(12) Patent Application Publication
(10) Pub. No.: US 2003/0145687 A1
(43) Pub. Date: Aug. 7, 2003

(54) Spanner provided with a drive shaft to rotate a workpiece in case of little working space

(75) Inventor: Yi-Chih Lin, Tainan City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wei Mo Jye Powertool Co., Ltd., Tainan City (TW)

(21) Appl. No.: 10/313,391

(22) Filed: Dec. 5, 2002

Related U.S. Application Data
(63) Continuation-in-part of application No. 10/067,621, filed on Feb. 4, 2002, now abandoned.

(51) Int. Cl. B25B 17/00

(52) U.S. Cl. 81/57.29

(57) ABSTRACT

A spanner includes a spanner body having a head portion that defines a socket receiving chamber confined by a peripheral wall, and a handgrip portion extending from the peripheral wall and defining a shaft-receiving chamber. A drive shaft is rotatably disposed in the shaft-receiving chamber. A connecting member is disposed rotatably in the socket receiving chamber, and engages the drive shaft via a coupling unit. An annular sleeve is disposed outwardly of the handgrip portion, is sleeved securely on one end of the to the drive shaft, and is formed with an elongated groove. A turning handle is pivoted to the sleeve, and is turnable between a used position, in which, the handle is disposed outwardly of the groove, and a storage position, in which, the handle is received in the groove.

### CROSS-REFERENCE OF RELATED APPLICATION

This invention is a Continuation-in-Part of co-pending U.S. patent application Ser. No. 10/067,621, entitled “SPANNER PROVIDED WITH A DRIVE SHAFT TO ROTATE A WORKPIECE IN CASE OF LITTLE WORKING SPACE” which was filed on Feb. 4, 2002.

### BACKGROUND OF THE INVENTION

1. Field of the Invention

The present invention relates to a spanner, more particularly to a spanner which includes a drive shaft that is disposed rotatably therein and that is capable of turning a workpiece in case the working space is too narrow to permit 360-degree rotation of the spanner during the tightening and loosening operation of the workpiece.

2. Description of the Related Art

Referring to FIG. 1, a conventional ratchet spanner is shown to include a spanner body 1 and a ratchet mechanism. The spanner body 1 has an annular head portion 101 defining a ratchet chamber 102 with an opening. The ratchet mechanism includes a ratchet wheel (not visible) disposed rotatably in the ratchet chamber 102, and a tool mounting shank 105 projecting outwardly of the ratchet chamber 102 for coupling the ratchet wheel with a socket (not shown) so as to drive a workpiece.

One drawback of the aforementioned conventional ratchet spanner resides in that the spanner body 1 requires a large working space to rotate the head portion 101 during the workpiece tightening or loosening operation.

### SUMMARY OF THE INVENTION

Therefore, the object of this invention is to provide a spanner which includes a drive shaft that is rotatably disposed therein and that is capable of turning a workpiece in case the working space is too narrow to permit 360-degree rotation of the spanner during tightening or loosening operation of the workpiece.

Accordingly, a spanner of the present invention includes: a spanner body having a head portion that includes a peripheral wall defining a socket receiving chamber therein, and a handgrip portion extending laterally from the peripheral wall and defining a shaft-receiving chamber that is in spatial communication with the socket receiving chamber; a drive shaft disposed rotatably in the shaft-receiving chamber, defining a first axis, and having a coupling end extending into the socket receiving chamber and an operating end opposite to the coupling end; a connecting member disposed rotatably in the socket receiving chamber; a coupling unit interposed between and connected to the connecting member and the peripheral wall in such a manner to permit synchronous rotation of the connecting member and the spanner body about a second axis which is transverse to the first axis; a gear unit disposed within the socket receiving chamber and engaging the connecting member and the drive shaft in such a manner that rotation of the drive shaft about the first axis results in rotation of the connecting member about the second axis relative to the spanner body; and an annular sleeve sleeved securely on the operating end of the drive shaft, and disposed outwardly of the handgrip portion. The annular sleeve is formed with an elongated groove that has an end. The spanner of the present invention further includes a turning handle pivoted to the sleeve at the end of the elongated groove, and turnable relative to the sleeve between a used position, in which the turning handle is disposed outwardly of the elongated groove for rotating the drive shaft about the first axis, and a storage position, in which the handle is received in the elongated groove in the sleeve.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a conventional ratchet spanner;

FIG. 2 is an exploded perspective view of a preferred embodiment of a spanner according to the present invention;

FIG. 3 is a fragmentary sectional view of the preferred embodiment, illustrating how a spring-biased pawl unit engages a ratchet wheel in a first condition to permit synchronous rotation of the ratchet wheel and a spanner body in a clockwise direction;

FIG. 4 is a fragmentary sectional view of the preferred embodiment, illustrating how the spring-biased pawl unit engages the ratchet wheel in a second condition to permit synchronous rotation of the ratchet wheel and the spanner body in a counterclockwise direction;

FIG. 5 is a schematic planar view illustrating how an externally operable pawl control element is mounted in the preferred embodiment shown in FIG. 2;

FIG. 6 is a sectional schematic side view of the preferred embodiment; and

FIG. 7 is a rear view of the preferred embodiment, illustrating a turning handle in a used position.

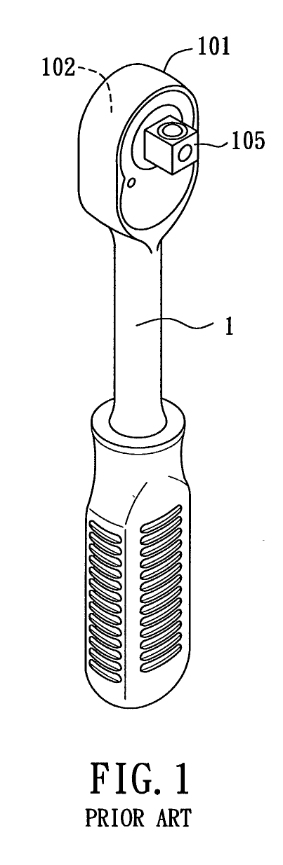

### DETAILED DESCRIPTION OF THE PREFERRED EMBODIMENT

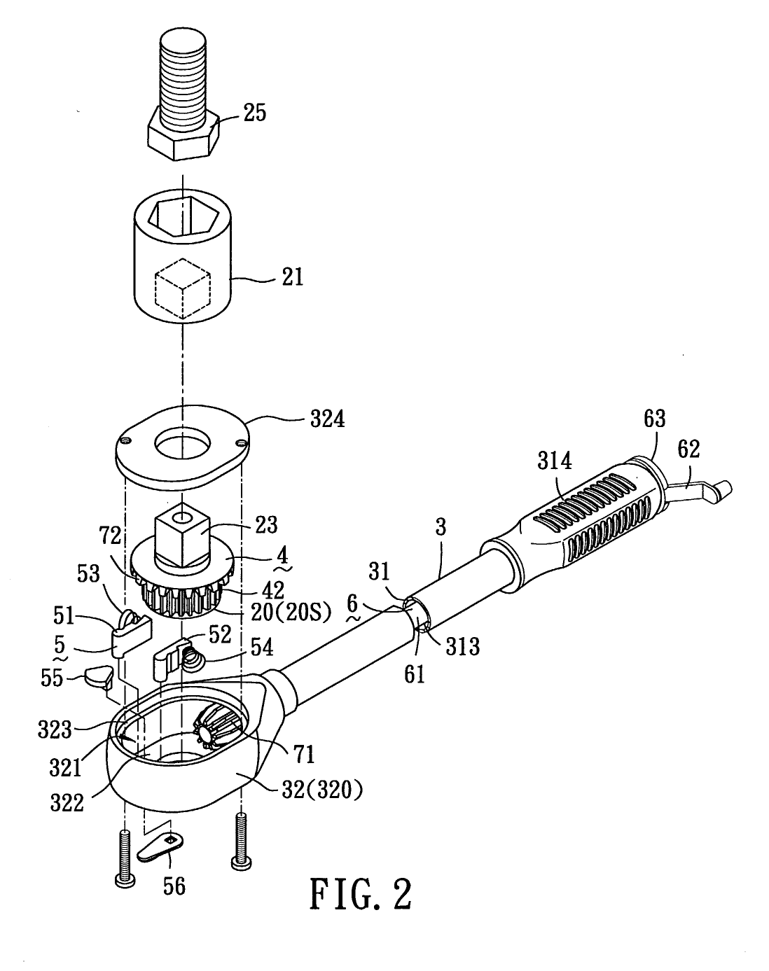

Referring to FIGS. 2, 3 and 4, the preferred embodiment of a spanner according to the present invention is shown to include a spanner body 3, a drive shaft 6, a connecting member 20, a coupling unit 4, a gear unit, an annular sleeve 63, and a turning handle 62.

As illustrated, the spanner body 3 has a head portion 32 that includes a peripheral wall 320 defining a socket receiving chamber 321 therein, and a handgrip portion 31 in the form of a hollow tubular member that extends laterally from the peripheral wall 320 and that defines a shaft-receiving chamber 313 which is in spatial communication with the socket receiving chamber 321.

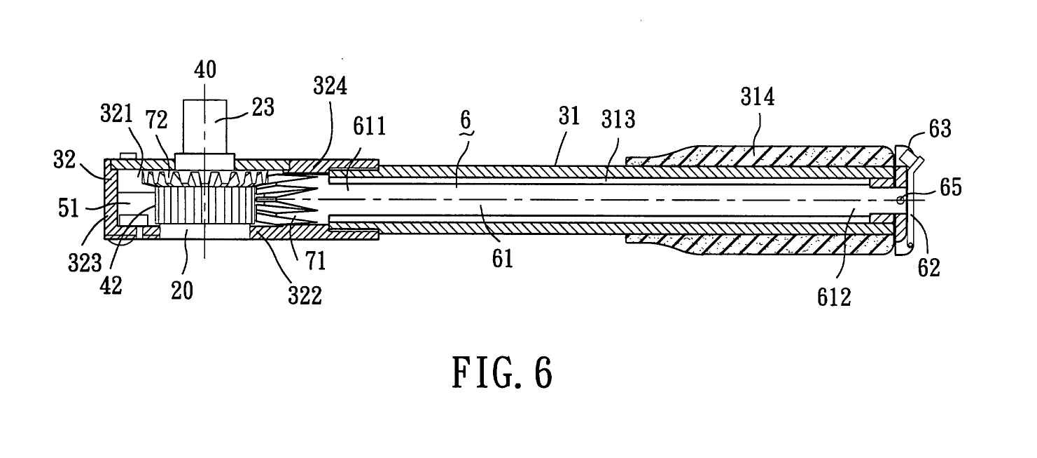

The drive shaft 6, in the form of a cylindrical rod 61, is disposed rotatably in the shaft-receiving chamber 313, defines a first axis, and has a coupling end 611 (see FIG.6) extending into the socket receiving chamber 321, and an operating end 612 opposite to the coupling end 611.

The connecting member 20 is disposed rotatably in the socket receiving chamber 321 of the head portion 32.

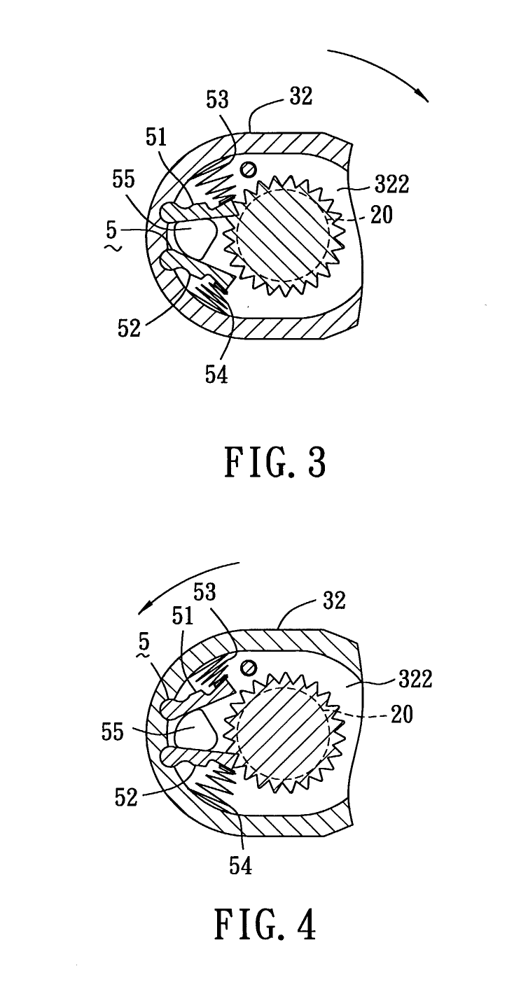

The coupling unit 4 is interposed between and connected to the connecting member 20 and the peripheral wall 320 in such a manner to permit synchronous rotation of the connecting member 20 and the spanner body 3 in a first direction about a second axis which is transverse to the first axis when the handgrip portion 31 is turned in the first direction (see FIGS. 3 and 4), and idle rotation of the spanner body 3 relative to the connecting member 20 when the handgrip portion 31 is turned in a second direction opposite to the first direction.

The gear unit is disposed within the socket receiving chamber 321, and engages the connecting member 20 and the drive shaft 6 in such a manner that rotation of the drive shaft 6 about the first axis results in rotation of the connecting member 20 about the second axis relative to the spanner body 3.

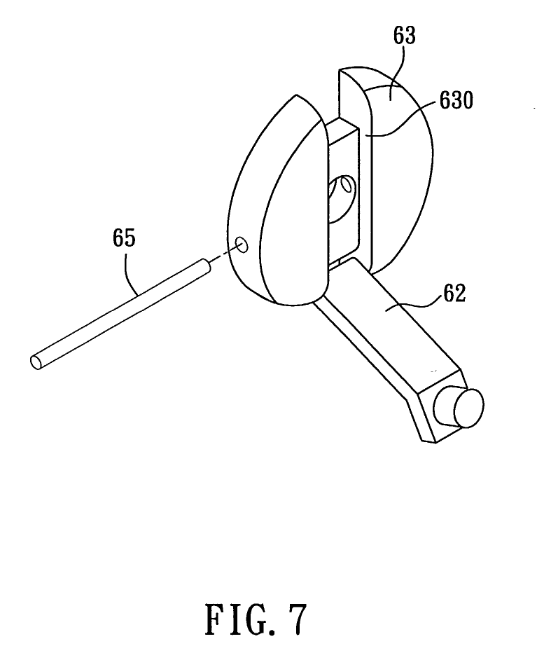

In this preferred embodiment, the annular sleeve 63 which is in the form of a disc and which is sleeved securely on the operating end 612 of the drive shaft 6 (see FIG. 6) via a pin 65 in such a manner that the sleeve 63 is disposed outwardly of the handgrip portion 31. The sleeve 63 is formed with an elongated groove 630 (see FIG. 7) that has an end. The turning handle 62 is pivoted to the sleeve 63 at the end of the elongated groove 630, and is thus turnable relative to the sleeve 63 between a used position, in which the turning handle 62 is disposed outwardly of the elongated groove 630 for rotating the drive shaft 6 about the first axis, as best shown in FIG. 7, and a storage position, in which the turning handle 62 is received in the elongated groove 630 in the sleeve 63, as best shown in FIG. 6. A rubber sheath 314 is mounted on the handgrip portion 31 to permit firm gripping by the user when the preferred embodiment is in use.

Preferably, the connecting member 20 includes a cylindrical portion (20S) mounted rotatably in the socket receiving chamber 321, and a socket-mounting portion 23 mounted co-axially on the cylindrical portion (20S) for coupling a socket 21 such that the socket-mounting portion 23 is exposed outwardly from the peripheral wall 320 for turning of a workpiece 25. The socket 21 defines a non-circular tool receiving hole to receive the workpiece 25 therein. The gear unit includes a first bevel gear 71 mounted securely on the coupling end 611 of the drive shaft 6, and a second bevel gear 72 which is co-axially fixed on the cylindrical portion (20S) and which meshes with the first bevel gear 71 so as to transmit rotation of the drive shaft 6 to drive the connecting member 20 to turn about the vertical axis.

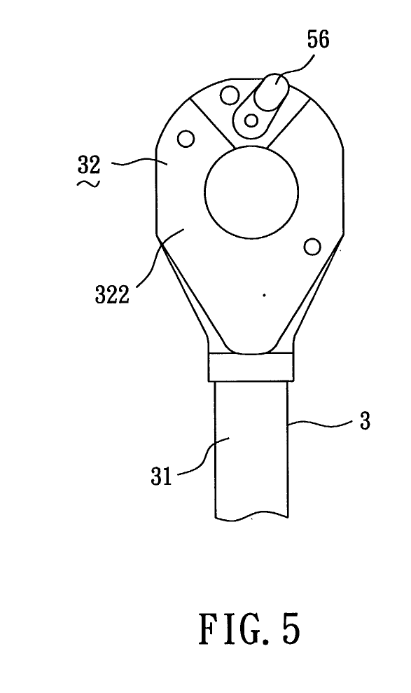

The coupling unit 4 includes a ratchet wheel 42, a spring-biased pawl unit 5, and a pawl control element 55. The ratchet wheel 42 is fixed on and surrounds the cylindrical portion (20S). The spring-biased pawl unit 5 includes opposing first and second pawls 51, 52, which are mounted pivotally in the socket receiving chamber 321 and which are biased by the coil springs 53, 54 to releasably engage the ratchet wheel 42. The pawl control element 55 is mounted pivotally in the socket receiving chamber 321 between and slidably contacts the first and second pawls 51, 52. As best shown in FIG. 5, a pawl actuating lever 56 is mounted on the peripheral wall 320, and is operably connected to the pawl control element 55 in such a manner that operation of the lever 56 results in pressing of a selected one of the first and second pawls 51, 52 against biasing action of a corresponding one of the coil springs 53, 54, thereby engaging the other one of the first and second pawls 51, 52 with the ratchet wheel 42, as best shown in FIGS. 3 and 4, and permitting co-rotation of the connecting member 20 and the spanner body 3 in a respective one of clockwise and counterclockwise directions.

In this preferred embodiment, the peripheral wall 320 has upper and lower ends, a bottom flange 322 that extends inwardly from the lower end to prevent downward removal of the ratchet wheel 42 and the cylindrical portion (20S) of the connecting member 20 from the peripheral wall 320, and a top flange 324 which extends inwardly from the upper end to prevent upward removal of the ratchet wheel 42 and the cylindrical portion (20S) from the peripheral wall 320 and which permits extension of the socket-mounting portion 23 therethrough. The peripheral wall 320 further has a flange-retaining rib 323 which extends inwardly from the peripheral wall 320 adjacent to the upper end thereof. The top flange 324 is disposed securely and detachably on the flange-retaining rib 323 so as to retain the cylindrical portion (20S) and the ratchet wheel 42 in the socket receiving chamber 321.

The advantages that result from the use of the spanner of this invention are as follows:

In case the working space of the spanner of the present invention is relatively narrow such that 360-degree rotation of the spanner body 3 during the tightening or loosening operation of the workpiece 25 is hindered, the workpiece 25 can be turned to a certain degree by mere rotation of the drive shaft 6 about the first axis in the shaft-receiving chamber 313 of the handgrip portion 31 without rotation of the spanner body 3 about the second axis. The workpiece 25 is then fully tightened or loosen by turning the spanner body 3 about the second axis.

Enhanced convenience results by virtue of the turning handle 62 since only a little force is needed to turn the drive shaft 6 by using the turning handle 62. Moreover, since the turning handle 62 is received in the elongated groove 630, interference by the turning handle 62 is avoided when using the handgrip portion 31 to the workpiece 25.

With this invention thus explained, it is apparent that numerous modifications and variations can be made without departing from the scope and spirit of this invention. It is therefore intended that the invention be limited only as indicated in the appended claims.

I claim:

1. A spanner comprising:
a spanner body having a head portion that includes a peripheral wall defining a socket receiving chamber therein, and a handgrip portion extending laterally from said peripheral wall and defining a shaft-receiving chamber that is in spatial communication with said socket receiving chamber;
a drive shaft disposed rotatably in said shaft-receiving chamber, defining a first axis, and having a coupling end extending into said socket receiving chamber and an operating end opposite to said coupling end;
a connecting member disposed rotatably in said socket receiving chamber;
a coupling unit interposed between and connected to said connecting member and said peripheral wall in such a manner to permit synchronous rotation of said connecting member and said spanner body about a second axis which is transverse to said first axis;
a gear unit disposed within said socket receiving chamber and engaging said connecting member and said drive shaft in such a manner that rotation of said drive shaft about said first axis results in rotation of said connecting member about said second axis relative to said spanner body;
an annular sleeve sleeved securely on said operating end of said drive shaft, and disposed outwardly of said handgrip portion, said sleeve being formed with an elongated groove that has an end; and
a turning handle pivoted to said sleeve at said end of said elongated groove and turnable relative to said sleeve between a used position, in which said turning handle is disposed outwardly of said elongated groove for rotating said drive shaft about said first axis, and a storage position, in which said turning handle is received in said elongated groove in said sleeve.

2. The spanner as defined in claim 1, wherein said connecting member includes a cylindrical portion disposed rotatably in said socket receiving chamber, and a socket-mounting portion co-axially formed with said cylindrical portion and exposed outwardly from said peripheral wall, said gear unit including a first bevel gear mounted securely on said coupling end of said drive shaft, and a second bevel gear which is co-axially fixed on said cylindrical portion and which meshes with said first bevel gear so as to transmit rotation of said drive shaft to drive said connecting member to turn about said second axis.

3. The spanner as defined in claim 2, wherein said coupling unit includes
a ratchet wheel fixed on and surrounding said cylindrical portion,
a spring-biased pawl unit having opposing first and second pawls, which are mounted pivotally in said socket receiving chamber and which are biased to releasably engage said ratchet wheel, and
a pawl control element mounted on said peripheral wall and operable externally so as to press selectively one of said first and second pawls against biasing action on said one of said first and second pawls, thereby engaging the other one of said first and second pawls with said ratchet wheel and permitting co-rotation of said connecting member and said spanner body.
